(19) United States
(12) Patent Application Publication
(10) Pub. No.: US 2006/0229808 A1
(43) Pub. Date: Oct. 12, 2006

(54) Route guidance device for vehicle

(75) Inventor: Daisuke Manabe, Kariya-city (JP)

Correspondence Address: POSZ LAW GROUP, PLC, 12040 SOUTH LAKES DRIVE, SUITE 101, RESTON, VA, 20191, US

(73) Assignee: DENSO CORPORATION, Kariya-city (JP)

(21) Appl. No.: 11/396,705

(22) Filed: Apr. 4, 2006

(30) Foreign Application Priority Data
Apr. 8, 2005 (JP) 2005-112823

(51) Int. Cl. G01C 21/32

(52) U.S. Cl. 701/210; 701/208

(57) ABSTRACT

A control circuit in a navigation device mounted in a vehicle detects a current position of the vehicle using a position detector when a target point is specified. The control circuit then determines whether information on a parking space corresponding to the specified target point is inputted or not. When the information is inputted, the control circuit stores the parking space indicated in the information as a parking space corresponding to the target point. The control circuit then calculates routes from the current position to the parking space and from the parking space to the target point to cause a display device to display the calculated routes.

### CROSS REFERENCE TO RELATED APPLICATION

This application is based on and incorporates herein by reference Japanese patent application No. 2005-112823 filed on Apr. 8, 2005.

### FIELD OF THE INVENTION

The present invention relates to a route guidance device.

### BACKGROUND OF THE INVENTION

In JP 2004-286519A, a conventional route guidance device is disclosed which selects a route including a stop-off point.

More specifically, the route guidance device receives an input for specifying multiple target points, and then retrieves parking spaces around the specified target points from a storage unit. The route guidance device further retrieves walk-around routes each of which starts at a parking space selected from the parking spaces, passes through the target points, and ends at the selected parking space. The route guidance device then selects a route, which is shortest among the walk-around routes, and causes a display device to display the selected route.

However, the parking spaces stored in the storage unit might not be up to date. There may be a case that the selected parking space is inappropriate for the specified target points.

### SUMMARY OF THE INVENTION

It is therefore an object of the present invention to provide a route guidance device for indicating a parking space appropriate for a specified target point.

In an aspect, a route guidance device for a vehicle of the present invention is provided with the following. An outputting device is included for outputting information by using at least one of an image and a sound. A position detection device is included for detecting a current position of the vehicle. A map data storage device is included for storing map data. A parking space storage device is included for storing (i) inputted information on a parking space, which is to be used for visiting a target point, and (ii) the target point, both of which are associated with each other. A control unit is included for calculating using the map data a route from the detected current position to the parking space, and for causing the output device to output information on the calculated route.

The route guidance device can thus inform the user of an appropriate parking space while suppressing a possibility that the information on the parking space is not up to date.

In another aspect, a route guidance device of the present invention is provided with the following. An outputting device is included for outputting information by using at least one of an image and a sound. A position detection device is included for detecting a current position of the vehicle. A map data storage device is included for storing map data. An inputting device is included for inputting information on a target point. An area detection device is included for detecting an area in which the vehicle is parked. A control unit is included for defining the detected area as a parking space when the area is within a predetermined distance from the target point. A parking space storage device is included for storing (i) information on the parking space and (ii) the target point, both of which are associated with each other. When information on a certain target point is inputted by the inputting device, the control unit searches the parking space storage device for information on a parking space associated to the certain target point. When the information associated to the certain target point is found, the control unit calculates a route from a current position detected by the position detection device to a parking space corresponding to the found information associated to the certain target point.

The route guidance device can thus inform the user of an appropriate parking space while suppressing a possibility that the information on the parking space is not up to date.

### BRIEF DESCRIPTION OF THE DRAWINGS

The invention, together with additional objective, features and advantages thereof, will be best understood from the following description, the appended claims and the accompanying drawings. In the drawings:

FIG. 1 is a block diagram showing an overall structure of a navigation device according to a first embodiment of the present invention;

FIG. 2 is a flowchart showing a process for route guidance executed by the navigation device;

FIG. 3A is a schematic view showing a recommended route from a current position to a target point;

FIG. 3B is a schematic view showing a recommended route from a current position through a parking space to a target point;

FIG. 4 is a flowchart showing a backup process executed by a navigation device according to a second embodiment of the present invention;

FIG. 5 is a flowchart showing a process executed by the navigation device for determining a parking space; and

FIG. 6 is a flowchart showing a process for route guidance executed by the navigation device.

### DETAILED DESCRIPTION OF THE PREFERRED EMBODIMENTS

### First Embodiment

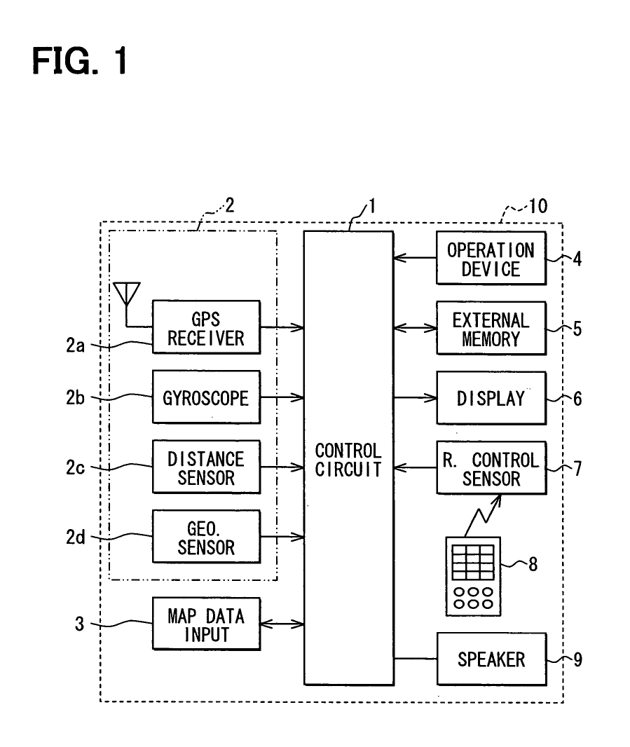

As shown in FIG. 1, a navigation device 10 as a route guidance device for a vehicle according to a first embodiment of the present invention includes a control circuit 1, a position detector 2, a map data inputting device 3, an operation device 4, external memory 5, a display device 6, a remote control sensor 7, a remote controller 8, and a speaker 9. The navigation device 10 is operated or turned on when an accessory (ACC) power of the vehicle is turned on.

The control circuit 1 for controlling an overall operation of the navigation device 10 as a control unit mainly includes a microcomputer which includes storage units (e.g., ROM, RAM, and EEPROM), an interface circuit, and bus lines for transferring data. The control circuit 1 specifies a recommended route according to programs stored in the storage units.

The position detector 2 includes a GPS (Global Positioning System) receiver 2a, a gyroscope 2b, a distance sensor 2c, and a geomagnetic sensor 2d, for detecting coordinates of a current position of the vehicle. The position detector 2 outputs the detected current position to the control circuit 1.

The sensors 2a to 2d have different types of detection accuracies. The position detector 2 detects the current position of the vehicle with a high accuracy by using the sensors 2a to 2d in a complementary style. The position detector 2 may have only a part of the sensors 2a to 2d depending on a required detection accuracy.

The map data inputting device 3 includes a storage medium storing map data. The map data includes road related data and search related data. The road related data are used in displaying a map or in executing route guidance, and include road data, marking data, facility data (polygon data), and background data. The search related data are used in searching for a target point (destination) or a facility close to a predetermined point, and include facility names and phone numbers. The storage medium is, for example, an HDD, which is rewritable.

The operation device 4 is, as an inputting device, for inputting to the control circuit 1 information depending on an inputting operation of a user. The information includes (i) target point information including a location of a target point, (ii) a search condition for searching for a target point, and (ii) an operation signal associated with a function of the navigation device 10 such as route retrieval of specifying a recommended route from a current position to target point. The operation device 4 includes a touch switch, push type mechanical switches, and a joystick. The touch switch is integrated on a screen of the display device 6. The push type mechanical switches are arranged around the screen of the display device 6. The joystick is for moving in many directions a cursor displayed on the screen of the display device 6. Each of the touch switch, the push type mechanical switches, and the joystick can be used independently or in combination.

A set of the remote control sensor 7 and the remote controller 8 is a remote controlling device having a function similar to that of the operation device 4. When the remote control sensor 7 receives an infrared signal transmitted by the remote controller 8, the remote control sensor 7 generates an operation signal and inputs it to the control circuit 1.

The external memory 5 is for storing, according to need, data used by the control circuit 1. For example, the external memory 5 stores parking space information including position information of a parking space (parking lot) while associating it with position information of a target point. The external memory 5 stores, for example, (i) a target point, (ii) parked area information related to the target point, and (iii) a parking count (or the number of parking), while these stored items are correlated (or associated) with each other. The parked area information is related to a parked area which is used for parking a vehicle and within a predetermined distance from a target point. The parking count or the number of parking indicates how many times the vehicle was parked in the parked area. The external memory 5 may store information related to a restriction (e.g., opening hours, a restriction on a height of a vehicle, or a restriction on a kind of a vehicle) for using the parking space. The external memory 5 may be a nonvolatile storage unit (e.g., HDD, EEPROM, or IC card) capable of storing data.

The display device 6 includes a screen (e.g., a color LCD display) to display a road map around the vehicle which is generated from the map data stored in the map data inputting device 3.

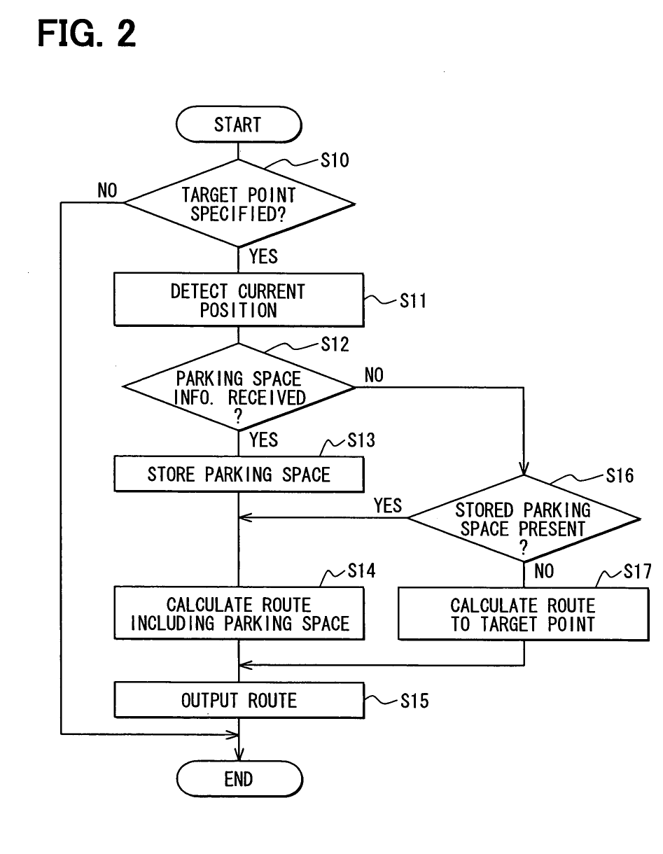

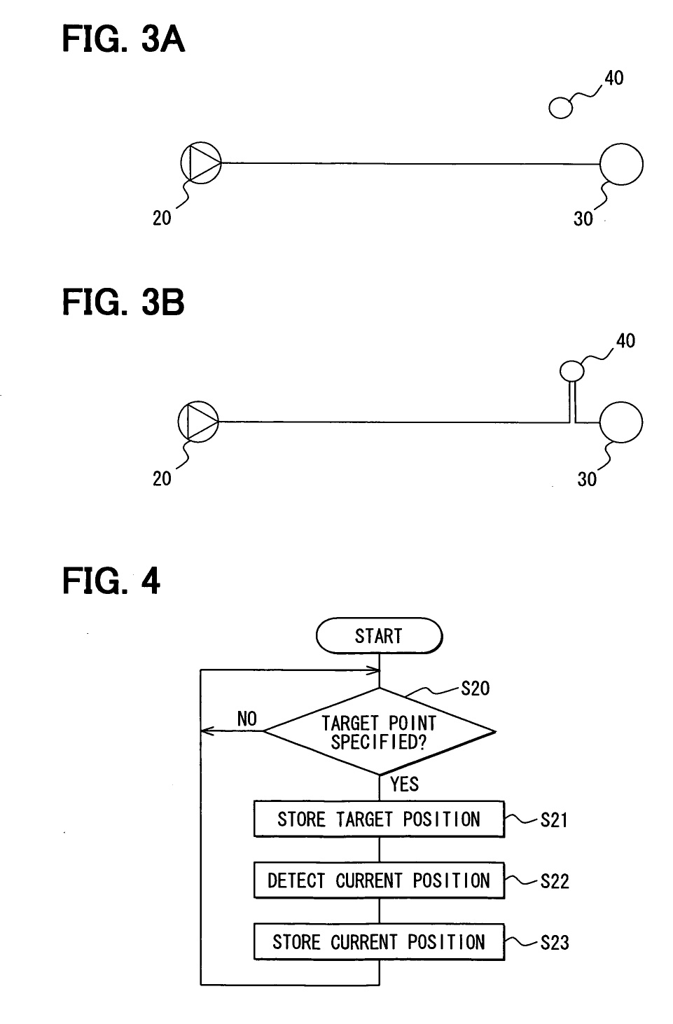

Hereinafter, an operation of the navigation device 10 for the route guidance is described with reference to FIGS. 2 and 3. The control circuit 1 executes the process in the FIG. 2 while an accessory (ACC) power of the vehicle is turned on (namely, the navigation device 10 is turned on).

The control circuit 1 determines at Step S10 whether a target point is specified or not. In other words, the control circuit 1 determines whether the control circuit 1 has received information on the target point (i.e., the target point information) via the operation device 4 or the remote control sensor 7. When the determination at Step S10 is affirmative, the control circuit 1 subsequently executes Step S11. When the determination at Step S10 is negative, the control circuit 1 executes Step S10 again. At Step S11, the control circuit 1 detects by using the position detector 2 a current position of the vehicle.

Subsequently at Step S12, the control circuit 1 determines whether the control circuit 1 receives parking space information via the operation device 4 or the remote control sensor 7. In other words, the control circuit 1 determines whether there is a parking space associated with the target point included in the target point information, that is, whether there is a parking space which can be used in visiting the target point. When the determination at Step S12 is affirmative, the control circuit 1 subsequently executes Step S13. When the determination at Step S12 is negative, the control circuit 1 subsequently executes Step S16.

At Step S13, the control circuit 1 specifies the parking space in the parking space information as a parking space corresponding to the target point in the target point information. At Step S13, the control circuit 1 stores in the external memory 5 or the like the specified parking space and the corresponding target point in a manner that the specified parking space and the corresponding target point are associated with each other.

The control circuit 1 thus stores the parking space and the target position while associating the parking space and the target position with each other, in order to notify a user of the parking space even when only the target point is specified by the user at the next time.

Another storage device such as an HDD (not illustrated) may store a associated pair of the target position and the parking space.

The control circuit 1 may erase or modify the associated pair of the target position and the parking space in the external memory 5 or the like when the control circuit 1 receives via the operation device 4 or the remote control sensor 7 a signal requesting for erasing or modifying the associated pair.

In the case that the control circuit 1 receives via the operation device 4 or the remote control sensor 7 a search condition (e.g., a facility name or a phone number) for searching for a target point and specifies the target point according to the search condition, the control circuit 1 may specify a parking space corresponding to the specified target point.

Subsequently at Step S14, the control circuit 1 calculates a route from the current position through the specified parking space to the corresponding target point.

Subsequently at Step S15, the control circuit 1 causes the display device 6 to display the information on the route calculated at Step S14. For example, the control circuit 1 causes the display device 6 to display as shown in FIG. 3B a route from the vehicle 20 (or the current position of the vehicle) to the specified parking space 40 and a route from the parking space 40 to the corresponding target position 30. The control circuit 1 may output the information on the route via the speaker 9 as a voice signal. The control circuit 1 may output the information on the route via both the speaker 9 and the display device 6.

The control circuit 1 may cause the display device 6 to display information on the specified parking space such as a location, opening hours, a restriction on a height of a vehicle, or a restriction on a kind of a vehicle together with the information on the route.

The control circuit 1 can thus inform the user of an appropriate parking space while suppressing a possibility that the information on the parking space is not up to date, by causing the display device 6 to display a recommended route from the current position through the inputted parking space to the target point.

The control circuit 1 may cause the display device 6 to display in a form (or way) a route from the current position to the parking space and to display in another form a second route from the parking space to the target point. In this case, the user can clearly distinguish a route to go through with a vehicle and a route to go through by walk (or on foot).

When the determination at Step S12 is negative, the control circuit 1 determines at Step S16 whether there is a parking space associated with the specified target position. More specifically, the control circuit 1 determines whether the external memory 5 or the like stores the parking space associated with the specified target position. When the determination at Step S16 is affirmative, the control circuit 1 subsequently executes Step S14. When the determination at Step S16 is negative, the control circuit 1 subsequently executes Step S17.

At Step S17, the control circuit 1 calculates by using the map data inputting device 3 information on a route from the current position to the target point in the received target point information. Subsequently at Step S15, the control circuit 1 causes the display device 6 to display the information on the route calculated at Step S17. For example, the control circuit 1 causes the display device 6 to display as shown in FIG. 3A a route from the vehicle 20 to the corresponding target position 30.

Thus, the control circuit 1 can inform the user of the parking space associated with the inputted target point by using the associated pair of the parking space and the target position stored in the storage unit, even if the control circuit 1 does not newly receive via the operation device 4 or the remote control sensor 7 the parking space information.

### Second Embodiment

Hereinafter, a second embodiment of the present invention will be described with reference to FIGS. 4 to 6.

A navigation device 10 of the second embodiment has the same hardware configuration as that of the navigation device 10 of the first embodiment. The navigation device 10 of the second embodiment is different from the navigation device 10 of the first embodiment in that the navigation device 10 of the second embodiment specifies a parking space to be used for a target point, based on information on the target point and a parked area in which the vehicle was previously parked. The navigation device 10 of the second embodiment executes a backup process, a parking space determination process, and a route guidance process, as shown in FIGS. 4, 5, and 6, respectively.

The control circuit 1 of the navigation device 10 continuously executes the backup process shown in FIG. 4 while the ACC power is turned on (namely, while the navigation device 10 is turned on).

In the backup process, the control circuit 1 first determines at Step S20 whether a target point is specified or not. In other words, the control circuit 1 determines whether the control circuit 1 has received target point information via the operation device 4 or the remote control sensor 7. When the determination at Step S20 is affirmative, the control circuit 1 subsequently executes Step S21. When the determination at Step S20 is negative, the control circuit 1 executes Step S20 again.

At Step S21, the control circuit 1 stores information on the target point in a backup storage medium (e.g., an EEPROM), e.g., the external memory 5, which keeps storing data even when the ACC power is turned off.

Subsequently at Step S22, the control circuit 1 detects by using the position detector 2 the current position of the vehicle, as a position in the parked area in which the vehicle is parked. Subsequently at Step S23, the control circuit 1 stores the detected current position in the backup storage medium. The stored information on the target point and current position is to be used later to determine whether a parked area in which the vehicle has been parked is within a predetermined distance from the target point.

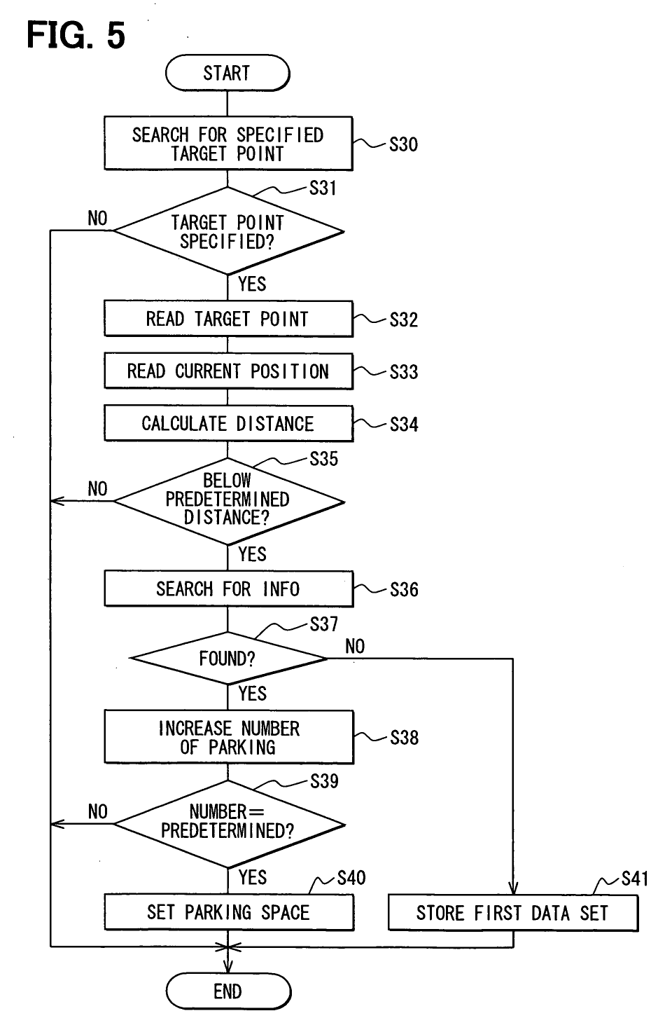

Next, in the parking space determination process, the control circuit 1 first starts executing the parking space determination process in FIG. 5 when the ACC power or the navigation device 10 is activated or tuned on (e.g., when a user of the vehicle rides in the parked vehicle and starts an ignition switch of the vehicle for driving the vehicle).

The control circuit 1 searches at Step S30 for information on the specified target point. In other words, the control circuit 1 searches for information on the target point stored in the backup storage medium. Subsequently at Step S31, the control circuit 1 determines whether a target point is specified or not based on a result of searching. Namely, if the information on the target point is stored, it is regarded that the target point has been specified. When the determination at Step S31 is affirmative, the control circuit 1 subsequently executes Step S32. When the determination at Step S31 is negative, the control circuit 1 terminates the parking space determination process.

At Step S32, the control circuit 1 reads the currently specified target point, which is stored in the backup storage medium. Subsequently at Step S33, the control circuit 1 reads the current position of the vehicle, which is stored in the backup storage medium.

Subsequently at Step S34, the control circuit 1 calculates a distance between the target point and the current position which were read from the backup storage medium at Steps S32 and S33.

Subsequently at Step S35, the control circuit 1 determines whether the distance calculated at Step S34 is smaller than a predetermined distance. When the determination at Step S35 is affirmative, the control circuit 1 subsequently executes Step S36. When the determination at Step S35 is negative, the control circuit 1 terminates the parking space determination process.

At Step S36, the control circuit 1 searches the external memory 5 for information on a parked area; this information is associated with the specified target point and includes the current position. As described later, the control circuit 1 stores and updates one or more first datasets in the external memory 5, according to operations at Step S38 and S41; this first dataset includes (i) a target point, (ii) a parked area corresponding to the target point, and (iii) the parking count in the parked area.

Subsequently at Step S37, the control circuit 1 determines whether the information on the parked area is found. When the determination at Step S37 is affirmative, the control circuit 1 subsequently executes Step S38. When the determination at Step S37 is negative, the control circuit 1 subsequently executes Step S41.

At Step S38, the control circuit 1 increases the parking count in the corresponding parked area. The parking count is used for setting the parked area to a parking space corresponding to a target point, which will be explained below.

Subsequently at Step S39, the control circuit 1 determines whether the increased parking count in the corresponding parked area has reached a predetermined value (or number). When the determination at Step S39 is affirmative, the control circuit 1 executes Step S40. When the determination at Step S39 is negative, the control circuit 1 terminates the parking space determination process.

At Step S40, the control circuit 1 sets the above corresponding parked area as a parking space for the specified target point, by storing in the external memory 5 a second dataset which includes information on the specified target point and the corresponding parking space, in a manner that the specified target point and the parking space are associated with each other.

The control circuit 1 may cause the display device 6 to display selection information for requesting the user to determine whether the parked area should be set as the parking space. In this case, the control circuit 1 sets the parked area as the parking space based on an affirmative determination of the user which is inputted via the operation device 4 or the remote control sensor 7.

The control circuit 1 thus sets, as the parking space for the specified target point, the parked area in which the vehicle was parked by the predetermined times or more. The navigation device 10 therefore informs the user of the appropriate parking space for the target point with high accuracy.

In contrast, at Step S41, the control circuit 1 defines, as a parked area corresponding to the specified target point, a predetermined area including the current position, and then stores in the external memory 5 a first dataset including the target point, the parked area, and the parking count indicating one. The predetermined area may correspond to an area which an ordinary parking space has or may correspond to polygon data indicating a parking space.

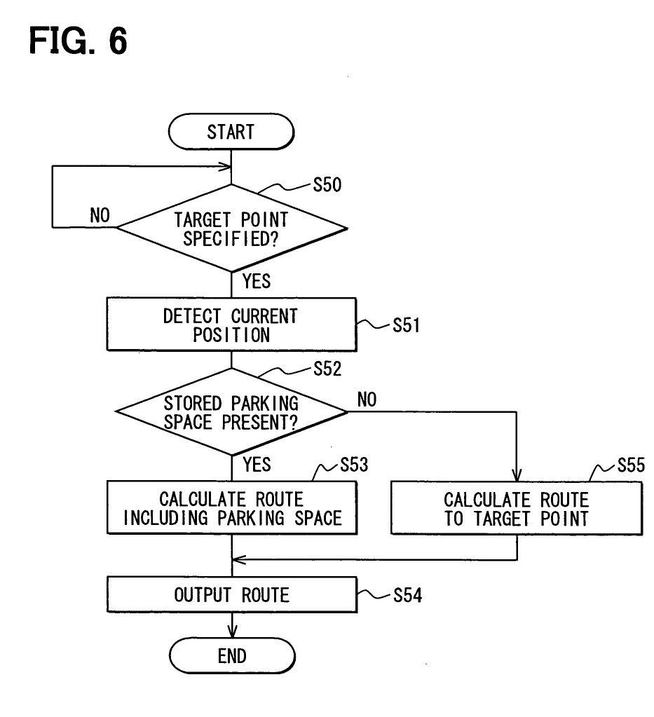

In the route guidance process shown in FIG. 6, the control circuit 1 first executes at Step S50 whether a target point is specified or not. In other words, the control circuit 1 determines whether the control circuit 1 has received target point information via the operation device 4 or the remote control sensor 7. When the determination at Step S50 is affirmative, the control circuit 1 subsequently executes Step S51. When the determination at Step S50 is negative, the control circuit 1 executes Step S50 again. At Step S51, the control circuit 1 detects by using the position detector 2 a current position of the vehicle.

Subsequently at Step S52, the control circuit 1 determines whether a parking space for the specified target point is stored in the external memory 5. In other words, the control circuit 1 determines whether the external memory 5 is storing a second dataset corresponding to the specified target point. When the determination at Step S52 is affirmative, the control circuit 1 subsequently executes Step S53. When the determination at Step S50 is negative, the control circuit 1 subsequently executes Step S55.

At Step S53, the control circuit 1 calculates, by using the map data inputting device 3, a route from the detected current position to the specified target point through the parking space found at Step S52. Subsequently at Step S54, the control circuit 1 causes the display device 6 to display the route calculated at Step S53.

At Step S55, the control circuit 1 calculates, by using the map data inputting device 3, a route from the detected current position to the specified target point. Subsequently at Step S54, the control circuit 1 causes the display device 6 to display the route calculated at Step S55.

As described above, the navigation device 10 sets a parked area as a parking space for a target point, when a distance from the target point to the parked area is within the predetermined distance and, additionally as needed, when the parking count reaches a predetermined number. Then the navigation device 10 stores information on the parking space in the external memory 5 in a manner that the parking space is associated with the target point.

In addition, when information on a target point is inputted via the operation device 4 or the remote control sensor 7 and information on a parking space related to the target point is stored in the external memory 5, a route from a current position to the target point through the parking space is calculated and outputted. The control circuit 1 can thus inform the user of an appropriate parking space while suppressing a possibility that the information on the parking space is not up to date, by causing the display device 6 to display a recommended route from the current position through the parking space to the target point.

(Modification)

For example, the navigation device 10 may set the parked area in which the vehicle is parked by at least one time as the parking space for the specified target point.

To calculate the parking count, the navigation device 10 stores in the external memory 5 the first dataset in which information on a target point, a parked area within the predetermined distance from the target point, and a parking count in the parked area. However, as long as the navigation device 10 can calculate the parking count using another method, the first dataset need not be stored in the external memory 5.

The navigation device 10 does not need to store in the backup storage medium the information on the target point while the ACC power is turned on, if the navigation device 10 can determine in another way whether the parked area where the vehicle is parked is within the predetermined distance from the target point.

The navigation device 10 does not need to store in the backup storage medium the current position of the vehicle while the ACC power is turned on, if the navigation device 10 can detect in another way a parked area in which the vehicle has been parked.

The navigation device 10 may cause the display device 6 to display only a route from the current position to the parking space corresponding to the specified target point.

There may be a case where the user repeats turning on and off the ACC power in a parked area where the vehicle is being parked. In this case, the number of parking or the parking count is increased inappropriately. Therefore, the control circuit 1 can be designed to increment the parking count only when the vehicle departs or travels a predetermined distance Lm or more, from the parked area after the ACC power is turned on.

Individual processing or execution explained in the above embodiment, e.g., using the flowchart can be constructed as a unit or means in a program stored in the ROM or the like and executed by using the CPU or the like.

It will be obvious to those skilled in the art that various changes may be made in the above-described embodiments of the present invention. However, the scope of the present invention should be determined by the following claims.

What is claimed is:

1. A route guidance device for a vehicle, comprising:
an outputting device for outputting information by using at least one of an image and a sound;
a position detection device for detecting a current position of the vehicle;
a map data storage device for storing map data;
a parking space storage device for storing (i) inputted information on a parking space, which is to be used for visiting a target point, and (ii) the target point, both of which are associated to each other; and
a control unit for calculating using the map data a route from the detected current position to the parking space, and for causing the output device to output information on the calculated route.

2. The route guidance device according to claim 1, further comprising:
an inputting device for inputting a search condition for searching for a target point and information on a parking space, based on an operation of a user, wherein
the control unit finds the target point satisfying the inputted search condition, and
the parking space storage device stores (i) the inputted information on the parking space and (ii) the target point found by the control unit, both of which are associated with each other.

3. The route guidance device according to claim 1, wherein
when only information on a certain target point, which is accompanied by no information on a parking space, is inputted, the control unit searches the parking space storage device for information on a parking space associated to the certain target point, and
when the information associated to the certain target point is found, the control unit calculates a route from a current position detected by the position detection device to a parking space corresponding to the found information associated to the certain target point.

4. The route guidance device according to claim 1, further comprising:
a parking restriction storage device for storing information on a restriction for using a parking space, wherein
the control unit causes the outputting device to output the stored information on the restriction for using the parking space together with the route from the calculated current position to the parking space.

5. The route guidance device according to claim 4, wherein
the information on the restriction for using the parking space includes at least one of opening hours of the parking space, a restriction on a height of the vehicle, and a restriction on a kind of the vehicle.

6. The route guidance device according to claim 1, wherein
the inputting device inputs an operation signal for erasing or modifying data stored in the parking space storage device based on an operation of a user, and
the control unit erases or modifies the data stored in the parking space storage device based on the inputted operation signal.

7. The route guidance device according to claim 1, wherein
the control unit calculates using the map data a route from the parking space to the target point and causes the output device to output information on the route from the parking space to the target point.

8. The route guidance device according to claim 7, wherein
the control unit causes the output device to output the information on the route from the current position to the parking space in a first form and to output the information on the route from the parking space to the target point in a second form different from the first form.

9. A route guidance device for a vehicle, comprising:
an outputting device for outputting information by using at least one of an image and a sound;
a position detection device for detecting a current position of the vehicle;
a map data storage device for storing map data;
an inputting device for inputting information on a target point;
an area detection device for detecting an area in which the vehicle is parked;
a control unit for defining the detected area as a parking space when the area is within a predetermined distance from the target point; and
a parking space storage device for storing (i) information on the parking space and (ii) the target point, both of which are associated with each other, wherein
when information on a certain target point is inputted by the inputting device, the control unit searches the parking space storage device for information on a parking space associated to the certain target point, and
when the information associated to the certain target point is found, the control unit calculates a route from a current position detected by the position detection device to a parking space corresponding to the found information associated to the certain target point.

10. The route guidance device according to claim 9, wherein
the control unit
calculates a parking count indicating how many times the vehicle is parked in the area, and
defines the area as the parking space when the calculated parking count is equal to or more than a predetermined value.

11. The route guidance device according to claim 10, further comprising:
an area information storage device for storing (i) information on the area located within the predetermined distance from the target point, and (ii) the parking count of the vehicle in the area, both of which are associated with each other, wherein
the control unit
updates the parking count in the area information storage device, based on (i) information on the target point inputted by the inputting device and (ii) an area detected by the area detection device, and
defines the area as the parking space based on the parking count stored in the area information storage device.

12. The route guidance device according to claim 11, further comprising:
a target point information storage device for storing and holding information on the target point inputted by the inputting device, regardless of whether an accessory power activating the route guidance device is turned on or off, wherein
at a time when the accessory power is switched from off to on,
the area detection device defines the area as a predetermined area including a current position detected by the position detection device, and
the control unit
searches, when the target point stored in the target point information storage device is within a predetermined distance from the defined area, the area information storage device for a pair of information on the defined area and information on the stored target point which are associated to each other;
increases, when the pair is found, a parking count which is associated to the pair in the area information storage device, and
causes, when the pair is not found, the area information storage device to store the information on the defined area, the information on the stored target point, and the parking count in the defined area, three of which are associated with each other.

13. The route guidance device according to claim 9, further comprising:
a current position storage device for storing and holding a current position detected by the position detection device, regardless of whether an accessory power activating the route guidance device is turned on or off, wherein
the area detection device defines the area as a predetermined area including the current position stored in the current position storage device at a time when the accessory power is switched from off to on.

14. The route guidance device according to claim 9, wherein
the control unit causes the outputting device to output information requesting to a user a selection of whether or not the detected area is defined as the parking space,
the inputting device inputs the selection based on an operation of the user, and
the control unit defines the detected area as the parking space based on the inputted selection.

15. The route guidance device according to claim 9, further comprising:
a parking restriction storage device for storing information on a restriction for using a parking space, wherein
the control unit causes the outputting device to output the stored information on the restriction for using the parking space together with the route from the calculated current position to the parking space.

16. The route guidance device according to claim 15, wherein
the information on the restriction for using the parking space includes at least one of opening hours of the parking space, a restriction on a height of the vehicle, and a restriction on a kind of the vehicle.

17. The route guidance device according to claim 9, wherein
the inputting device inputs an operation signal for erasing or modifying data stored in the parking space storage device based on an operation of a user, and
the control unit erases or modifies the data stored in the parking space storage device based on the inputted operation signal.

18. The route guidance device according to claim 9, wherein
the control unit calculates using the map data a route from the parking space to the target point and causes the output device to output information on the route from the parking space to the target point.

19. The route guidance device according to claim 18, wherein
the control unit causes the output device to output the information on the route from the current position to the parking space in a first form and to output the information on the route from the parking space to the target point in a second form different from the first form.

20. The route guidance device according to claim 11, wherein
the area detection device defines the area as a predetermined area including a current position detected by the position detection device at a time when an accessory power activating the route guidance device is switched from off to on, and
the control unit
searches the area information storage device for a pair of information on the defined area and the target point which are associated with each other, when the target point is within a predetermined distance from the defined area,
increases, when the pair is found, parking count which is associated to the pair in the area information storage device, and
prohibits the parking count from increasing until the vehicle goes out of the defined area, after the accessory power is turned on and the parking count once increases.

21. The route guidance device according to claim 11, wherein
the area detection device defines the area as a predetermined area including a current position detected by the position detection device at a time when an accessory power activating the route guidance device is switched from off to on, and
the control unit
searches the area information storage device for a pair of information on the defined area and the target point which are associated to each other, when the target point is within a predetermined distance from the defined area,
increases, when the pair is found, parking count which is associated to the pair in the area information storage device, and
prohibits the parking count from increasing until the vehicle travels a predetermined distance from the defined area, after the accessory power is turned on and the parking count once increases.
